(19) United States
(12) Patent Application Publication
(10) Pub. No.: US 2024/0301118 A1
(43) Pub. Date: Sep. 12, 2024

(54) STABLE POLY(ALKYL ALDEHYDE)S

(71) Applicant: BOISE STATE UNIVERSITY, Boise, ID (US)

(72) Inventors: Scott Phillips, Boise, ID (US); Kyle Nogales, Nampa, ID (US)

(73) Assignee: BOISE STATE UNIVERSITY, Boise, ID (US)

(21) Appl. No.: 18/574,658

(22) PCT Filed: Jul. 1, 2022
(86) PCT No.: PCT/US22/36025

§ 371 Date: Dec. 27, 2023

Related U.S. Application Data
(60) Provisional application No. 63/218,037, filed on Jul. 2, 2021.

(51) Int. Cl. C08G 2/30; C08G 2/14; C08L 59/00

(52) U.S. Cl. CPC C08G 2/30; C08G 2/14; C08L 59/00; C08G 2150/00; C08G 2170/00; C08L 2203/14; C08L 2203/16

(57) ABSTRACT

A substance may include polymers that include reagent end-capped poly(acetal)s, where a differential scanning calorimetry process exhibits no endothermic peaks for monomers for a first heat cycle of a heat-cool process applied to the reagent end-capped poly(acetal)s and for a second heat cycle of the heat-cool process. The disclosed polyacetals are stable at 23° C., open to the air, for at least 1 month.

### CROSS-REFERENCE TO RELATED APPLICATIONS

This application claims the benefit of U.S. Provisional Application No. 63/217,951, filed on Jul. 2, 2021 and U.S. Provisional Patent Application No. 63/218,037, filed Jul. 2, 2021, and entitled “Stable Poly(Alkyl Aldehyde)s,” the contents of both are incorporated by reference herein in their entirety.

### GOVERNMENT LICENSE RIGHTS

This invention was made with government support under contract no. W911NF-17-1-0608 awarded by the US Army Research Laboratory. The government has certain rights in the invention.

### FIELD OF THE DISCLOSURE

This disclosure is generally related to the field of Poly(acetal)s and, in particular, to stable Poly(acetal)s.

### BACKGROUND

Poly(acetal)s are a broad class of polymers that are obtained by polymerization of aldehydes, either under anionic or Lewis acidic conditions. Methods for stabilizing some poly(acetal)s include using aldehydes that are highly electron deficient, generating cyclic versions of poly(acetal)s that are generated from aromatic dialdehyde monomers, incorporating additives to scavenge adventitious acids or radicals, or end capping polymers so that the polymers are not terminated as hemiacetals.

Highly electron deficient aldehydes, in particular, are most effective at providing stable, non-cyclic poly(acetal)s. The simplest example is formaldehyde, which generates poly(acetal)s that are stable due to the high ceiling temperature of the polymer. Other examples include poly(acetal)s made from monomers such as ethyl glyoxaldehyde, methyl glyoxaldehyde, CF₃CHO, CF₂ClCHO, CF₂BrCHO, CFCl₂CHO, and CFClBrCHO, all of which form poly(acetal)s with ceiling temperatures that are above 23° C.

The direct relationship between polymer stability and highly electron deficient aldehyde monomers may limit the scope of the class of poly(acetal)s since most aldehydes are not as highly electron deficient as the examples in the previous paragraph. In fact, poly(acetal)s may be unstable at 23° C. when prepared from alkyl aldehydes, where alkyl is defined as being a carbon substituent with an electronegativity value equal to or less than the CCl₃ group in the aldehyde CCl₃CHO.

Various methods exist for end-capping poly(alkyl aldehyde)s, but none specifically address the issue of removing hydrogen end-capped polymers that may contaminate the desired end-capped polymers. Hydrogen end-capped polymers are not stable at room temperature, and the aldehyde depolymerization products readily oxidize in air to generate carboxylic acids. These acids catalyze degradation of the end-capped poly(alkyl aldehyde)s, rendering the class of polymers unstable.

It should, therefore, be appreciate that there remains a need for a method for preparing poly(acetal)s that are stable as solids at ambient temperatures in order to have a usable shelf life without signs of degradation via depolymerization, as well as a method that is amenable to common aldehydes that are not as highly electron deficient.

### SUMMARY

Disclosed herein are stable, reagent end-capped polymers and stable, linear poly(acetal)s, and methods for synthesis, end capping, and recycling stable poly(acetal)s that overcomes at least one of the shortcomings described above. In particular, the disclosed polyacetals are stable at 23° C., open to the air, for at least 1 month.

In an embodiment, a substance includes polymers that include reagent end-capped poly(acetal)s. The reagent end-capped poly(acetal)s are such that a differential scanning calorimetry process exhibits no endothermic peaks for monomers for a first heat cycle of a heat-cool process applied to the reagent end-capped poly(acetal)s and for a second heat cycle of the heat-cool process. The first heat cycle and the second heat cycle extend to a temperature at which hydrogen end-capped poly(acetal)s thermally depolymerize. A cooling cycle of the heat-cool process extends to −180° C.

In an embodiment, a method for obtaining stable polyacetals includes synthesizing a polymer substance. The polymer substance includes hydrogen end-capped polymer and reagent end-capped polymer. The method includes removing the hydrogen end-capped polymer from the polymer substance.

For purposes of summarizing the disclosure and the advantages achieved over the prior art, certain advantages of the disclosure have been described herein. Of course, it is to be understood that not necessarily all such advantages may be achieved in accordance with any particular embodiment of the disclosure. Thus, for example, those skilled in the art will recognize that the disclosure may be embodied or carried out in a manner that achieves or optimizes one advantage or group of advantages as taught herein without necessarily achieving other advantages as may be taught or suggested herein.

All of these embodiments are intended to be within the scope of the disclosure. These and other embodiments will become readily apparent to those skilled in the art from the following detailed description of the preferred embodiments having reference to the attached figures, the disclosure not being limited to any particular preferred embodiment disclosed.

### BRIEF DESCRIPTION OF THE DRAWINGS

The accompanying drawings, which are included to provide a further understanding of the disclosure, by way of example only, and are incorporated in and constitute a part of this specification, illustrate embodiments and together with the description serve to explain the principles of the disclosed methods and products. In the drawings:

FIG. 1 depicts the process for preparing the poly(acetal)s, end-capping the polymers, and purifying the polymers by removing hydrogen end-capped polymer impurities along with monomer that is generated during the purification process.

FIG. 2 is a representative thermogram for a heat-cool-heat cycle using a differential scanning calorimeter (DSC) of hydrogen end-capped poly(octanal). The dashed line represents the first heat cycle, while the dark lines reveal the second heat cycle.

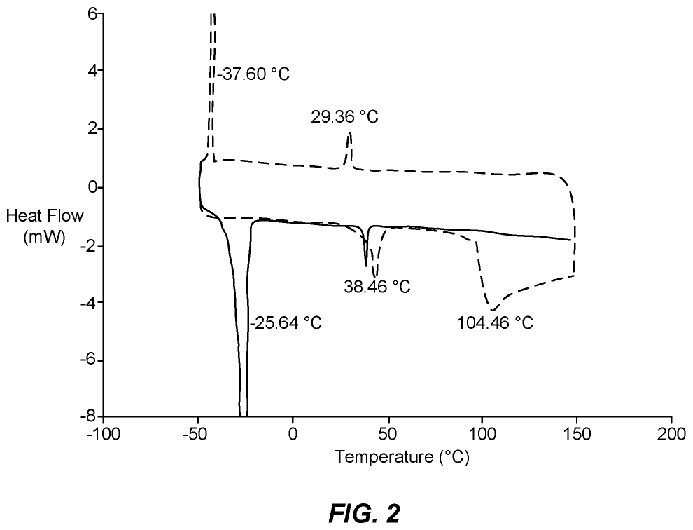

FIG. 3 is a representative thermogram for a heat-cool-heat cycle using DSC for butyrate end-capped poly(octanal) that is contaminated with hydrogen end-capped poly(octanal). The dashed line represents the first heat cycle, while the dark lines reveal the second heat cycle.

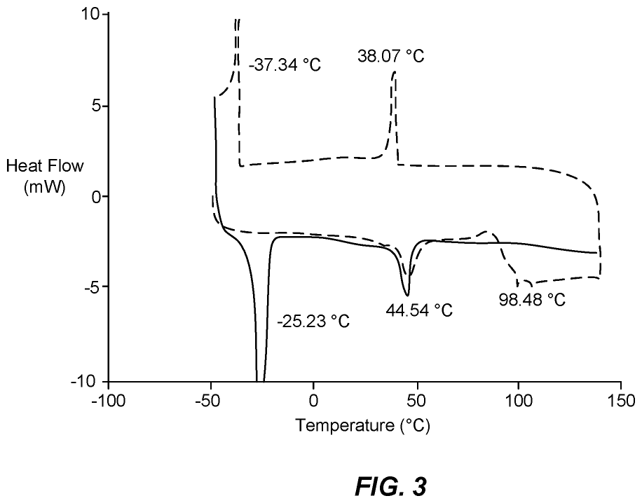

FIG. 4 is a representative thermogram for a heat-cool-heat cycle using DSC for butyrate end-capped poly(octanal) that does not contain hydrogen end-capped poly(octanal). The dashed line represents the first heat cycle, while the dark lines reveal the second heat cycle.

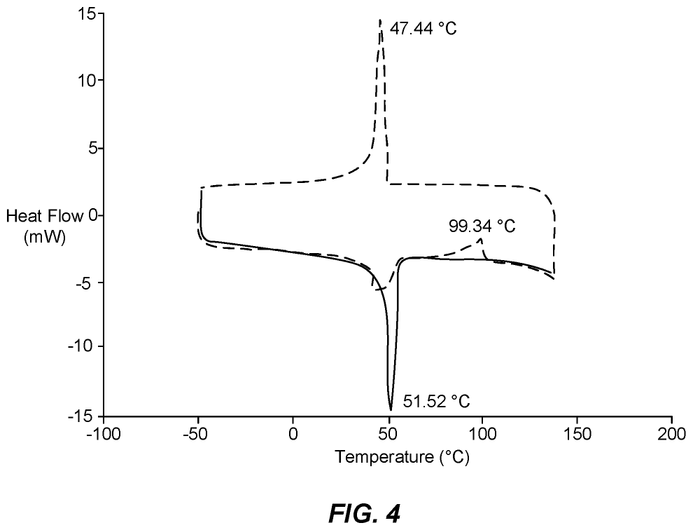

FIG. 5 is a thermogram for octanal, which is the monomer that is obtained when hydrogen or reagent end-capped poly(octanal) depolymerizes.

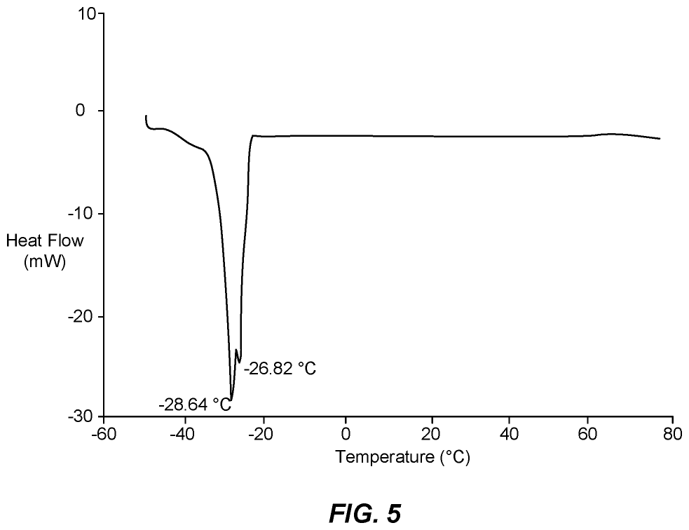

FIG. 6 is a representative thermogram for a heat-cool-heat cycle using DSC for tert-butyldimethylsilyl (TBS) end-capped poly(butanal) that does not contain hydrogen end-capped poly(butanal). The dashed line represents the first heat cycle, while the dark lines reveal the second heat cycle.

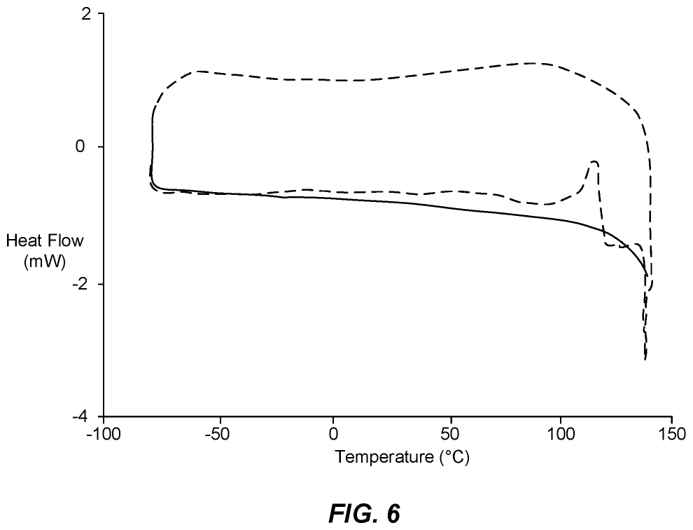

FIG. 7 is a representative thermogram for a heat-cool-heat cycle using DSC for TBS end-capped poly(hexanal) that does not contain hydrogen end-capped poly(hexanal). The dashed line represents the first heat cycle, while the dark lines reveal the second heat cycle.

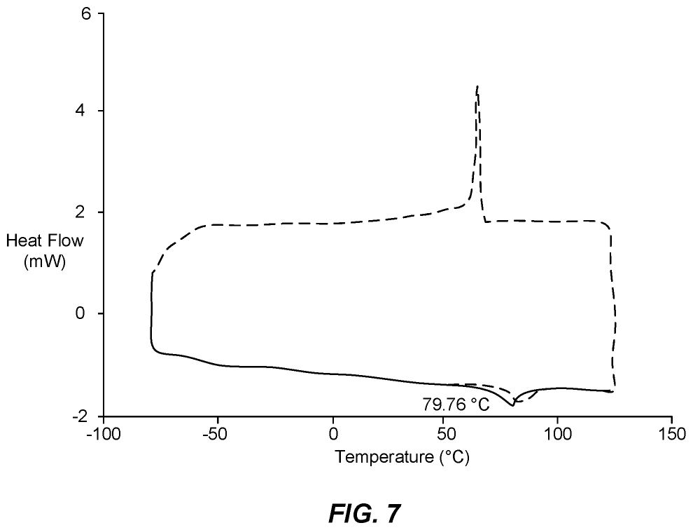

FIG. 8 is a representative thermogram for a heat-cool-heat cycle using DSC for butyrate end-capped poly(pentanal) that does not contain hydrogen end-capped poly(pentanal). The dashed line represents the first heat cycle, while the dark lines reveal the second heat cycle.

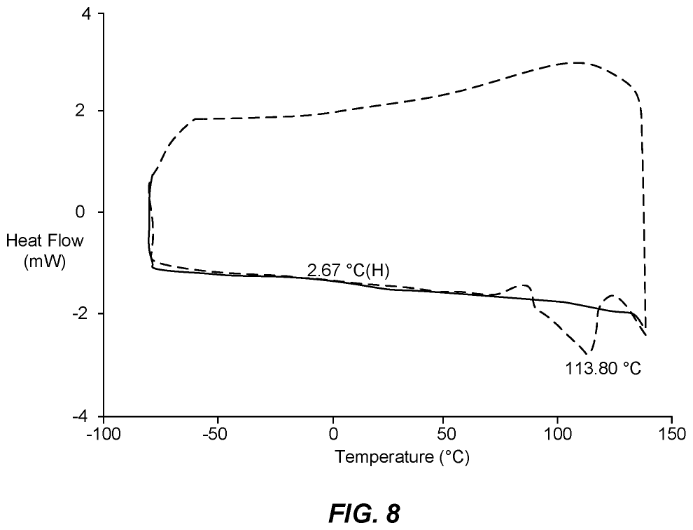

FIG. 9 is a representative thermogram for a heat-cool-heat cycle using DSC for TBS end-capped poly(methional) that does not contain hydrogen end-capped poly(methional). The dashed line represents the first heat cycle, while the dark lines reveal the second heat cycle.

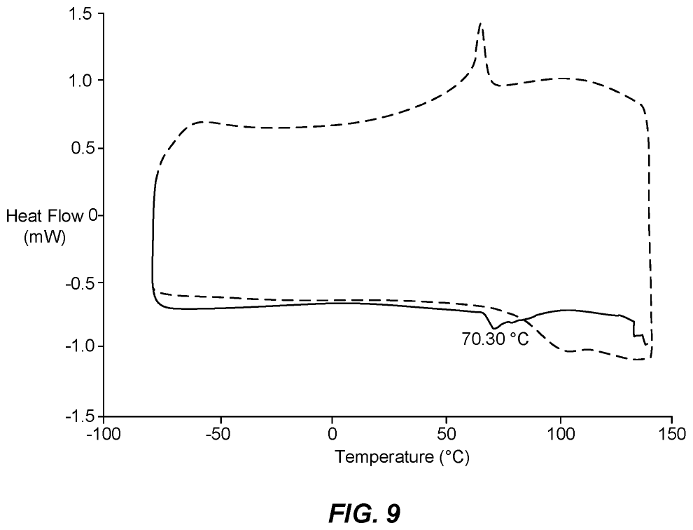

FIG. 10 is a representative thermogram for a heat-cool-heat cycle using DSC for TBS end-capped poly(propanal) that does not contain hydrogen end-capped poly(propanal). The dashed line represents the first heat cycle, while the dark lines reveal the second heat cycle.

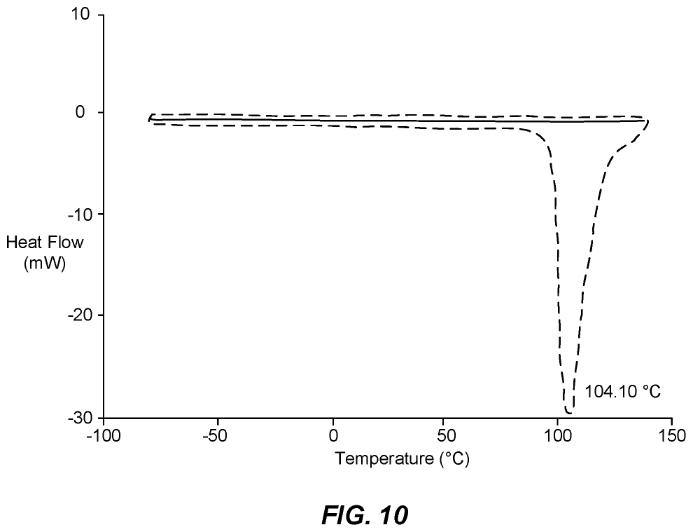

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the scope of the disclosure.

### DETAILED DESCRIPTION

The term “aldehyde” is used herein to refer to a compound containing one or more aldehyde (—CHO) groups or a group capable of forming a reactive aldehyde group, where the aldehyde groups are capable of reacting with the aldehyde-reactive groups (e.g., amino or amido groups) of a polymer as described herein.

The term “alkyl” is used herein primarily to refer to a moiety containing mostly saturated hydrocarbons that are linear, branched, or cyclic, where the number of carbon atoms permit branching or cyclization.

The term “polymer” refers to synthetic homo- or copolymers, as well as synthetic modifications or derivatives thereof having a linear, branched or star structure. Polymers can be further modified to enhance their mechanical or degradation properties by purification, introducing cross-linking agents or changing the hydrophobicity of the side residues.

The term “copolymer” is used herein primarily to refer to polymers containing copolymerized units of at least two different monomers (i.e., a dipolymer). Copolymers can be arranged in any form, such as, e.g., random, block, segmented, tapered blocks, graft, or triblock.

As used herein, the term “depolymerize” means to convert from a polymer to at least one of small molecules, short oligomers or monomers. The depolymerization may be complete, substantially complete, incomplete or substantially incomplete. The term “depolymerizable” means able to depolymerize.

The phrase “non-ambient stimulus” is used herein to refer to a material or condition that is not in the environment in which the plastic article is conventionally used but when introduced in the presence of the plastic article causes some type of response by one or more components of the plastic article. When ranges are used herein for physical properties, all combinations, and sub-combinations of ranges specific embodiments therein are intended to be included.

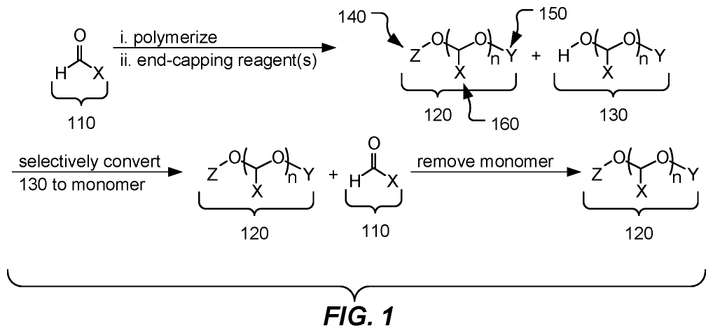

Referring to FIG. 1, a process for preparing the poly(acetal)s, end-capping the polymers, and purifying the polymers by removing hydrogen end-capped polymer impurities along with a monomer that is generated during the purification process is depicted.

The process may begin with a poly(acetal) prepared from alkyl aldehydes 110, where the alkyl is designated as X in FIG. 1. The alkyl aldehydes 110 may polymerize and end-capping reagent(s) may produce a reagent-end capped polymer 120 and a hydrogen end-capped polymer 130. The polymers 120, 130 including a first side group Z 140, a second side group Y 150, and a third side group X 160, where side groups are described further herein with respect to specific examples. As described further herein, with respect to specific examples, the hydrogen end-capped polymer 130 may be selectively converted to the monomer 110 and subsequently removed, resulting in the purification of the reagent end-capped polymer.

Purifying reagent end-capped polymers to remove hydrogen end-capped polymers can increase poly(acetal) stability, shown by the percentage of remaining polymer when the polymers are stored as solids at 23° C., open to the air. The percentage of remaining polymer was determined by 1H NMR. Several such non-limiting examples are illustrated in Table 1 below:

TABLE 1

| | | % of solid polymer remaining after | % of solid polymer remaining after |
|---|---|---|---|
| | | 7 days at 23º C., open to air | 35 days at 23º C., open to air |
| 610 | 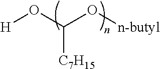 | 7 | 0 |
| 620 | 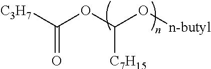 | 29 | 2 |
| | (not purified by exposing to NaH) | | |
| | (Mₙ = 290 kDa) | | |
| 630 | 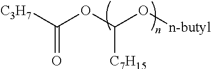 | 100 | 100 |
| | (purified by washing with NaH) | | |
| | (Mₙ = 258 kDa) | | |
| 640 | 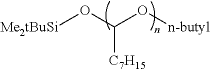 | 100 | 100 |
| | (purified by washing with NaH) | | |
| | (Mₙ = 134 kDa) | | |

In an embodiment, end caps, polymer length, hydrophobic side groups, and branched side groups may all impact the thermal stability of the poly(acetal)s, as illustrated by, but not limited to Table 2 below:

| | | onset of thermal decomposition | onset of thermal decomposition |
|---|---|---|---|
| | | (from thermal gravimetric analysis) | (from differential scanning calorimetry) |
| 710 | 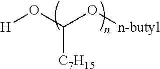 | 124° C. | |
| 720 | 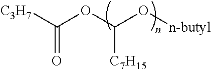 | 134° C. | |
| | (not purified by exposing to NaH) | | |
| | (Mₙ = 290 kDa) | | |
| 730 | 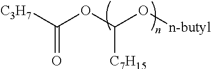 | 152° C. | |
| | (purified by washing with NaH) | | |
| | (Mₙ = 258 kDa) | | |
| 740 | 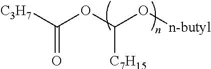 | 187º C. | 225° C. |
| | (purified by washing with NaH) | | |
| | (Mₙ = 134 kDa) | | |
| 750 | 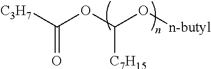 | | 130° C. |
| | (purified by washing with NaH) | | |
| | (Mₙ = 61 kDa) | | |
| 760 | 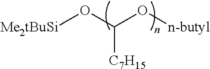 | | 136° C. |
| | (purified by washing with DBU) | | |
| | (Mₙ = 80 kDa) | | |
| 770 | 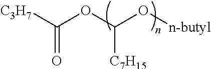 | | 185° C. |
| | (purified by washing with NaH) | | |
| | (Mₙ = 628 kDa) | | |
| 780 | 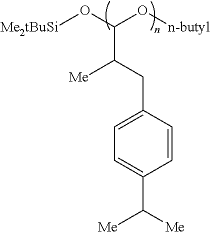 | | 197° C. |
| | (purified by washing with NaH) | | |
| | (Mₙ = 21 kDa) | | |
| 790 | 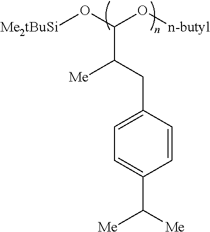 | | 222° C. |
| | (purified by washing with NaH) | | |
| | (Mₙ = 44 kDa) | | |

In embodiments, poly(acetal)s may be prepared using one or more of a variety of substrates selected from, but not limited to Table 3 below:

TABLE 3

| | | T_{g} | Tₘ | Tₒ | Mₙ |
|---|---|---|---|---|---|
| | | (º C.) | (0° C.) | (º C.) | (kDa) |
| 801 | 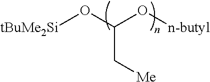 | | | 136 | 50 |
| 802 | 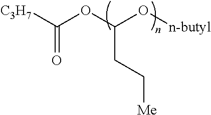 | 69 | | 142 | |
| 803 | 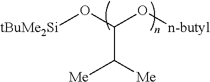 | 65 | 99 | 115 | |
| 804 | 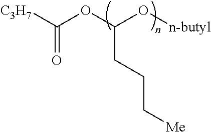 | | 140 | 155 | |
| 805 | 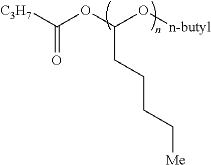 | | 75 | 151 | 210 |
| 806 | 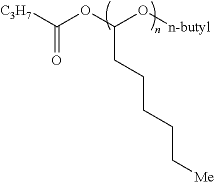 | 57 | 85 | 140 | 211 |
| 807 | 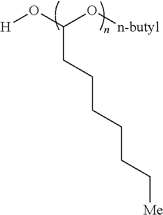 | | 44 | 98 | 174 |
| 808 | 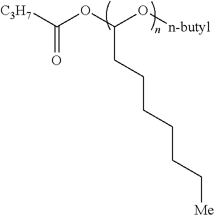 | | 52 | 150 | 626 |
| 809 | 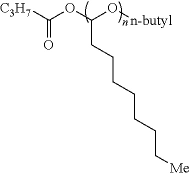 | | 54 | 110 | 369 |
| 810 | 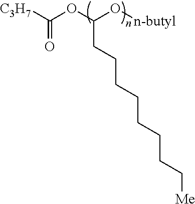 | 25 | 62 | 117 | 169 |
| 811 | 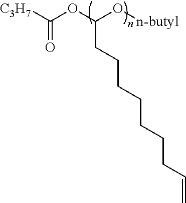 | | 60 | 143 | 591 |
| 812 | 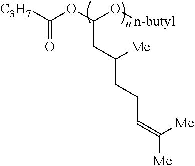 | | | 155 | |
| 813 | 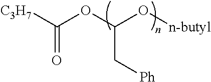 | 103 | 207 | 219 | |
| 814* | 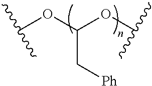 | | | 178 | |
| | *From Lewis Acid-catalyzed | | | | |
| | polymerization | | | | |
| 815 | 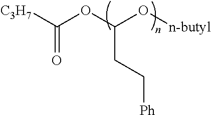 | 50 | | 135 | 1591 |
| 816 | 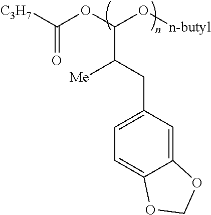 | | | 174 | 18 |
| 817 | 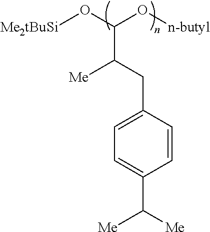 | | | 197 | 21 |
| 818 | 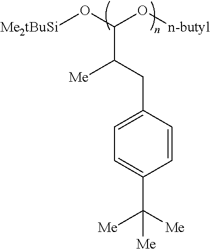 | 55 | | 215 | 26 |
| 819 | 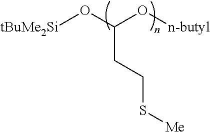 | −50 | 81 | 140 | |
| 820* | 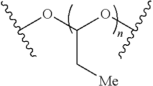 | | | 108 | 41 |
| | *From Lewis Acid-catalyzed | | | | |
| | polymerization | | | | |
| 821* | 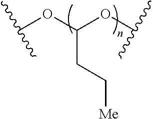 | | −1 | 118 | 75 |
| | *From Lewis Acid-catalyzed | | | | |
| | polymerization | | | | |
| 822* | 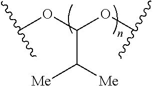 | | | 110 | 775 |
| | *From Lewis Acid-catalyzed | | | | |
| | polymerization | | | | |

In certain aspects, embodiments are directed to methods of recycling an article made from the polymer(s), which may include exposing the article to a non-ambient stimulus for a time sufficient to depolymerize the polymers that make up the article. The non-ambient stimulus can be at least one material selected from the group consisting of base, acid, oxidizing agent, reducing agent, non-ionizing radiation (including ultraviolet light, ultraviolet-visible light, infrared radiation, microwave, radio waves, thermal radiation (heat)), ultrasound, and combinations thereof. The exposure duration of the article to the non-ambient stimulus can range from about 10 minutes to about 120 minutes.

In an embodiment, polymers may take the following form:

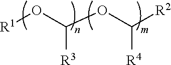

where n may be from 1-1000 units, m may be from 0-1000 units. R¹ may each, independently, include (C₁-C₂₀)alkyl, allyl, 1-propynyl,

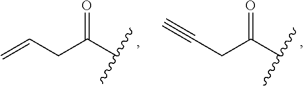

benzyl, triphenylmethyl,

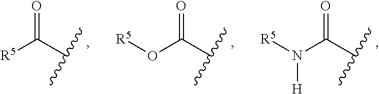

—SiR⁵, furfuryl, or R⁶ (described further below), or substituents containing alkynes, alkenes, maleimide, silyl ethers, a carbon-bromine bond, or furan. R²=each, independently, (C₁-C₂₀)alkyl, isopropyl, tert-butyl, phenyl, benzyl, allyl, 1-propynyl,

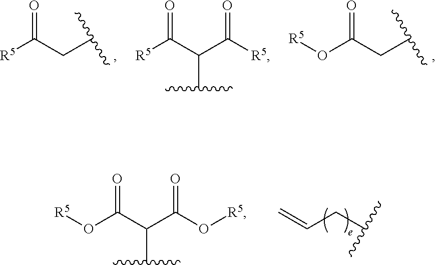

(where e ranges from 1 to 20 in this example and in each of the examples in which e is referenced),

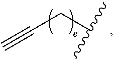

furfuryl, or substituents containing alkynes, alkenes, maleimide, silyl ethers, a carbon-bromine bond, or furan. R³ may each include, independently, many possibilities, such as Ethanal, Propanal, Butanal, Isobutyraldehyde, Pentanal, Hexanal, Heptanal, Octanal, Nonanal, Decanal, Undecanal, 10-undecanal, Dodecanal, 2-methylbutyraldehyde, 2-methylpentanal, 2-ethylhexanal, propanal/octanal co-polymer, 3(Methylthio)propionaldehyde (methional), beta-methylmercapto-propionaldehyde, beta-ethylmercapto-propionaldehyde, beta-propylmercapto-propionaldehyde, beta-n-butylmercapto-propionaldehyde, beta-hexylmercapto-propionaldehyde, beta-phenylmercapto-propionaldehyde, beta-methylmercapto-butyraldehye, beta-ethylmercapto-butyraldehye, beta-propylmercapto-butyraldehye, beta-n-butylmercapto-butyraldehye, beta-hexylmercapto-butyraldehye, beta-phenylmercapto-butyraldehye, cyclohexanecarboxaldehyde, cyclohex-3-enecarboxaldehyde, 5-Norborene-2-carboxaldehyde, 2-phenylethanal, 2-phenylpropanal, 3-phenylpropanal, 3-phenylbutyraldehyde, furfural, 2-methyl-3-(3,4-methylenedioxyphenyl)propionylaldehyde (helional), 3-(4-tert-Butylphenyl)-2-methylpropanal (lilial), 3-(4-Isopropylphenyl)-2-methylpropanal (cyclamen aldehyde), 2,2,2-trichloroacetaldehyde (chloral), 2,2,2-trichloroacetaldehyde, 2-bromo-2,2-dichloroacetaldehyde, 2,2-dibromo-2-chloroacetaldehyde, and 2,2,2-tribromoacetaldehyde, among others. R⁴ may each include, independently, the same possibilities as R³. R⁵ may each include, independently, (C₁-C₂₀)alkyl, phenyl, benzyl, allyl, furfuryl, or 1-propynyl, or substituents containing alkynes, alkenes, maleimide, silyl ethers, a carbon-bromine bond,

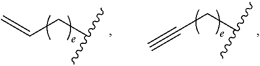

or furan. R⁶ may include an end cap that cleaves in response to a specific applied stimulus. As may be appreciated, n and m units may form a random or block copolymer, or a crosslinked derivative of the above formula, or a cyclic polymer, or polymers with atactic, syndiotactic, or isotactic stereochemical configurations.

In certain embodiments R⁶ may be, independently,

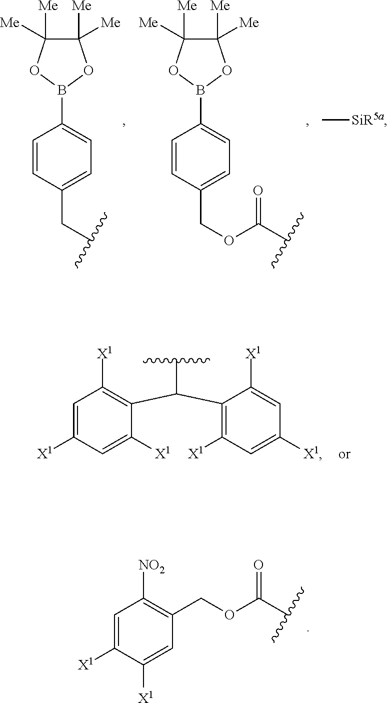

R^{5a} may each include, independently, (C₁-C₂₀)alkyl, phenyl, benzyl, allyl, furfuryl, or 1-propynyl, or substituents containing alkynes, alkenes, maleimide, silyl ethers, a carbon-bromine bond,

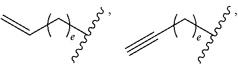

or furan. X¹ may each include, independently, H, (C₁-C₂₀)alkoxy, or NR^{5b}. R^{5b} may each include, independently, (C₁-C₂₀)alkyl.

Specific non-limiting examples of the formation of purified reagent end-capped polymers may include steps as described below:

### Example 1

Preparation of poly(10-undecenal): A 150 mL round bottom flask with a stir bar and distillation glassware was removed from the oven and cooled inside a desiccator. Once cooled to room temperature, the distillation apparatus was assembled with ˜1 g of molecular sieves in the receiving flask. The 150-mL flask and distillation apparatus were flame dried under vacuum three times and cooled under a blanket of Argon. Once cooled, 25 mL of 10-undecenal was added to the distillation flask and was distilled under vacuum (10-undecenal bp ˜67° C. at 1 torr). After the distillation was complete, 20 mL of freshly distilled 10-undecenal (95 mmol) was added to the 150 mL flask and was diluted with 50 mL of anhydrous toluene (2M). The flask was cooled to −65° C. 10-undecenal may solidify in solution. To solve this issue, take the flask out of the cold bath until the monomer goes back into solution. Only initiate once the monomer is in solution. Once the solution is chilled, and the monomer is in solution, add 0.59 mL n-butyl lithium (1.6M, 1 mmol) to the round bottom flask. Stir under Argon for 16 h. The solution may become viscous. To the polymerization reaction, add N,N-Diisopropylethylamine (DIEA) (0.33 molar equivalents), and then tert-butyldimethylsilyl trifluoromethanesulfonate (0.25 molar equivalents) at a rate of 2 mL/min (running the reagents down the inside of the cold flask) and ensure that the end-capping reagents are mixed through the viscous polymer solution. Stir (if possible) for 16 h at −65° C., then warm to room temperature over 2 h. Once at room temperature, precipitate into methanol (4:1 anti-solvent:solvent) by pouring the viscous solution all at once. Filter the precipitate using a glass frit and dry under vacuum overnight.

Purification of poly(10-undecenal): Dissolve polymer in BHT-free THF (10 mL THF/gram of polymer). If the polymer does not dissolve continue to add THF until the polymer dissolves. Once dissolved, add 1,8-Diazabicyclo[5.4.0]undec-7-ene (DBU) dropwise (0.1 mL DBU/gram of polymer). Stir for 30 min and then precipitate into methanol (4:1 anti-solvent:solvent). Filter the precipitate using a glass frit and dry under vacuum overnight. Dissolve polymer in THF (10 mL THF/gram of polymer). If the polymer does not dissolve continue to add THF until the polymer dissolves and precipitate into methanol (4:1 anti-solvent:solvent). Filter the precipitate using a glass frit and dry under vacuum overnight.

Determining if hydrogen end-capped polymer is present in poly(10-undecenal) using a heat-cool-heat cycle: If hydrogen end-capped polymer is present, dissolve polymer in BHT-free THF, then add NaH (1 mg NaH/gram of polymer). Stir the solution for 10 min and precipitate into methanol (4:1 anti-solvent:solvent). Filter and dry the polymer under vacuum overnight. Dissolve the polymer in THF and precipitate into precipitate into methanol (4:1 anti-solvent:solvent). Filter and dry under vacuum overnight. Determine if hydrogen end-capped polymer is present using a heat-cool-heat cycle. If hydrogen end-capped polymer is present, repeat NaH treatment until detection of hydrogen end-capped polymer is not possible using differential scanning calorimetry (DSC).

Verification of the purity of poly(10-undecenal): Repeat a heat-cool-heat DSC experiment on poly(10-undecenal) from −50° C. to 125° C. at a ramp rate of 5°/min. Purity is determined by visualizing a monomer peak on the second heat cycle of the DSC spectrum.

### Example 2

Preparation and purification of butyryl end-capped poly(octanal): 100 mL of freshly distilled octanal (640 mmol, 1 equivalent) that was dried over 4 Å molecular sieves was added to a 500 mL round bottom flask with a stir bar. The flask was charged with 320 mL of anhydrous Toluene (2M) and the solution was cooled to −65° C. Once cooled, 10 mL of 1.6M n-butyl lithium in hexanes (16 mmol, 0.025 equivalents) was added and the solution was cooled for 5 hours. After 5 hours, 16 mL of butyryl chloride (160 mmol, 0.25 equivalents) and 37 mL of N,N-diisopropylethylamine (211 mmol, 0.33 equivalents) were added to the flask and the solution was cooled at −65° C. for 16 hours before warming to room temperature over 2 hours. The solution was precipitated into 1400 mL of methanol and the white precipitate was filtered and dried overnight at 1 torr to produce 26 grams of poly(octanal), 32% yield. Poly(octanal) was further purified by dissolving 26 grams into 500 mL of THF and adding 0.25 mL of DBU. The solution was precipitated into 1400 mL of methanol and was filtered and dried overnight at 1 torr. The remaining 24 grams of poly(octanal) was again dissolved in 500 mL of THF and 12 mg of NaH was added and stirred for 10 minutes. After 10 minutes, the solution was precipitated into 1400 mL of methanol and the precipitate was filtered and dried overnight at 1 torr. Lastly, 24 grams of poly(octanal) was dissolved in 500 mL of THF and was precipitated into 1400 mL of methanol. The precipitate was filtered and dried overnight at 1 torr to produce 24 grams of poly(octanal), 29% yield.

### Example 3

Preparation of poly(citronellal): A 300 mL round bottom flask with a stir bar and distillation glassware was removed from the oven and cooled inside a desiccator. Once cooled to room temperature, the distillation apparatus was assembled with ˜5 g of molecular sieves in the receiving flask. The 300 mL flask and distillation apparatus were flame dried under vacuum three times and cooled under a blanket of Argon. Once cooled, 150 mL of citronellal (TCI) was added to the distillation flask and was distilled under vacuum. After the distillation was complete, 115 mL of freshly distilled citronellal (638 mmol) was added to the 500 mL flask and was diluted with 212 mL of anhydrous Toluene (3M). The flask was cooled to −70° C. After 1 hour, 10 mL n-butyl lithium (1.6M, 16 mmol, 0.025 molar equivalents) was added to the round bottom flask. Stir under Argon for 4 h. The solution may become viscous. To the polymerization reaction, add N,N-Diisopropylethylamine (DIEA) (36 mL, 210 mmol, 0.33 molar equivalents), and then butyric chloride (16.4 mL, 160 mmol, 0.25 molar equivalents) at a rate of 5 mL/min (running the reagents down the inside of the cold flask) and ensure that the end-capping reagents are mixed through the viscous polymer solution. The solution was stirred at −70° C. for 16 hours, then warm to room temperature over 2 hours. Once at room temperature, precipitate into methanol (4:1 anti-solvent:solvent) by pouring the viscous solution all at once. Filter the precipitate using a glass frit and dry under vacuum overnight.

Purification of poly(citronellal): Dissolve poly(citronellal) in 200 mL THF. Once dissolved, add 1 mL 1,8-Diazabicyclo[5.4.0]undec-7-ene (DBU) dropwise. Stir for 30 min and then precipitate into methanol (4:1 anti-solvent:solvent). Filter the precipitate using a glass frit and dry under vacuum overnight. Dissolve poly(citronellal) in 200 mL THF. Once dissolved, add 10 mg sodium hydride (NaH). Stir for 10 min and then precipitate into methanol (4:1 anti-solvent:solvent). Filter the precipitate using a glass frit and dry under vacuum overnight.

### Example 4

Preparation of poly(cyclamen): A 300 mL round bottom flask with a stir bar and distillation glassware was removed from the oven and cooled inside a desiccator. Once cooled to room temperature, the distillation apparatus was assembled with ˜5 g of molecular sieves in the receiving flask. The 300 mL flask and distillation apparatus were flame dried under vacuum three times and cooled under a blanket of Argon. Once cooled, 150 mL of cyclamen was added to the distillation flask and was distilled under vacuum. After the distillation was complete, 100 mL of freshly distilled cyclamen (500 mmol) was added to the 500 mL flask and was diluted with 200 mL of anhydrous toluene (2.5M), then 1 mL of 15-crown-5 was added. The flask was cooled to −78° C. After 1 hour, 3.125 mL n-butyl lithium (1.6M, 5 mmol, 0.01 molar equivalents) was added to the round bottom flask. Stir under Argon for 5 h. The solution may become viscous. To the polymerization reaction, add N,N-Diisopropylethylamine (DIEA) (13 mL, 75 mmol, 0.15 molar equivalents), and then tert-butyldimethylsilyl trifluoromethanesulfonate (11.5 mL, 50 mmol, 0.1 molar equivalents) at a rate of 5 mL/min (running the reagents down the inside of the cold flask) and ensure that the end-capping reagents are mixed through the viscous polymer solution. Stirred at −78° C. for 16 hours, then warm to room temperature over 2 hours. Once at room temperature, precipitate into methanol (4:1 anti-solvent:solvent) by pouring the viscous solution all at once. Filter the precipitate using a glass frit and dry under vacuum overnight.

Purification of poly(cyclamen): Dissolve poly(cyclamen) in 500 mL THF. Once dissolved, add 5 mL 1,8-Diazabicyclo[5.4.0]undec-7-ene (DBU). Stir for 30 min and then precipitate into methanol (4:1 anti-solvent:solvent). Filter the precipitate using a glass frit and dry under vacuum overnight. Dissolve poly(cyclamen) in 500 mL THF and then precipitate into methanol (4:1 anti-solvent:solvent). Filter the precipitate using a glass frit and dry under vacuum overnight.

### Example 5

Preparation of poly(decanal): A 300 mL round bottom flask with a stir bar and distillation glassware was removed from the oven and cooled inside a desiccator. Once cooled to room temperature, the distillation apparatus was assembled with ˜5 g of molecular sieves in the receiving flask. The 300 mL flask and distillation apparatus were flame dried under vacuum three times and cooled under a blanket of Argon. Once cooled, 150 mL of decanal (TCI) was added to the distillation flask and was distilled under vacuum. After the distillation was complete, 141 mL of freshly distilled decanal (750 mmol) was added to the 500 mL flask and was diluted with 250 mL of anhydrous toluene (3M). The flask was cooled to −65° C. After 1 hour, 11.7 mL n-butyl lithium (1.6M, 18.75 mmol, 0.025 molar equivalents) was added to the round bottom flask. Stir under Argon for 6 h. The solution may become viscous. To the polymerization reaction, add N,N-Diisopropylethylamine (DIEA) (20 mL, 112 mmol, 0.15 molar equivalents), and then butyric chloride (8 mL, 75 mmol, 0.1 molar equivalents) at a rate of 5 mL/min (running the reagents down the inside of the cold flask) and ensure that the end-capping reagents are mixed through the viscous polymer solution. Stirred at −65° C. for 16 hours, then warm to room temperature over 2 hours. Once at room temperature, precipitate into methanol (4:1 anti-solvent:solvent) by pouring the viscous solution all at once. Filter the precipitate using a glass frit and dry under vacuum overnight.

Purification of poly(decanal): Dissolve poly(decanal) in 200 mL THF then 10 mg of sodium hydride (NaH) was added. Stir for 30 min and then precipitate into methanol (4:1 anti-solvent:solvent). Filter the precipitate using a glass frit and dry under vacuum overnight. Dissolve poly(decanal) in 250 mL THF then precipitate into methanol (4:1 anti-solvent:solvent). Filter the precipitate using a glass frit and dry under vacuum overnight. Determine if hydrogen end-capped polymer is present using a heat-cool-heat cycle. If hydrogen end-capped polymer is present, repeat NaH treatment until no hydrogen end-capped polymer is present using DSC.

Verification of purity of poly(decanal): Run a heat-cool-heat cycle DSC experiment on poly(decanal) from −50° C. to 125° C. at a ramp rate of 5°/min. Check to see if any monomer is present on the second heat cycle.

### Example 6

Preparation of poly(helional): A 100 mL round bottom flask with a stir bar and distillation glassware was removed from the oven and cooled inside a desiccator. Once cooled to room temperature, the distillation apparatus was assembled with ˜1 g of molecular sieves in the receiving flask. The 100 mL flask and distillation apparatus were flame dried under vacuum three times and cooled under a blanket of Argon. Once cooled, 25 mL of helional was added to the distillation flask and was distilled under vacuum. After the distillation was complete, 16 mL of freshly distilled helional (96 mmol) was added to the 100 mL flask and was diluted with 32 mL of anhydrous THF (3M). The flask was cooled to −78° C. After 0.5 hour, add 0.6 mL n-butyl lithium (1.6M, 0.96 mmol, 0.01 molar equivalents) to the round bottom flask. Stir under Argon for 4 h. The solution may become viscous. To the polymerization reaction, add N,N-Diisopropylethylamine (DIEA) (5.5 mL, 32 mmol, 0.33 molar equivalents), and then butyric chloride (2.5 mL, 24 mmol, 0.25 molar equivalents) at a rate of 2 mL/min (running the reagents down the inside of the cold flask) and ensure that the end-capping reagents are mixed through the viscous polymer solution. Stir (if possible) for 16 h at −78° C., then warm to room temperature over 2 h. Once at room temperature, precipitate into methanol (4:1 anti-solvent:solvent) by pouring the viscous solution all at once. Filter the precipitate using a glass frit and dry under vacuum overnight.

Purification of poly(helional): Poly(helional) was dissolved in 200 mL BHT-free THF. Once dissolved, 0.25 mL 1,8-Diazabicyclo[5.4.0]undec-7-ene (DBU) was added dropwise. Stir for 30 min and then precipitate into methanol (4:1 anti-solvent:solvent). Filter the precipitate using a glass frit and dry under vacuum overnight.

### Example 7

Preparation of poly(heptanal): A 100 mL round bottom flask with a stir bar and distillation glassware was removed from the oven and cooled inside a desiccator. Once cooled to room temperature, the distillation apparatus was assembled with ˜1 g of molecular sieves in the receiving flask. The 100 mL flask and distillation apparatus were flame dried under vacuum three times and cooled under a blanket of Argon. Once cooled, 75 mL of heptanal (TCI) was added to the distillation flask and was distilled under Argon (heptanal bp ˜153° C. at 760 torr). After the distillation was complete, 8 mL of freshly distilled heptanal (57 mmol) was added to the 50 mL flask and was diluted with 14 mL of anhydrous toluene (4M). The flask was cooled to −78° C. After 0.5 hour, 0.35 mL n-butyl lithium (1.6M, 0.57 mmol, 0.01 molar equivalents) was added to the round bottom flask. Stir under Argon for 6 h. The solution may become viscous. To the polymerization reaction, add N,N-Diisopropylethylamine (DIEA) (1.5 mL, 8.55 mmol, 0.15 molar equivalents), and then tert-butyldimethylsilyl trifluoromethanesulfonate (1.3 mL, 5.7 mmol, 0.15 molar equivalents) at a rate of 1 mL/min (running the reagents down the inside of the cold flask) and ensure that the end-capping reagents are mixed through the viscous polymer solution. The solution was stirred at −78° C. for 16 hours, then warm to room temperature over 2 hours. Once at room temperature, precipitate into methanol (4:1 anti-solvent:solvent) by pouring the viscous solution all at once. Filter the precipitate using a glass frit and dry under vacuum overnight.

Purification of poly(heptanal): Dissolve poly(heptanal) in 20 mL THF. Once dissolved, add 0.1 mL 1,8-Diazabicyclo[5.4.0]undec-7-ene (DBU). Stir for 30 min and then precipitate into methanol (4:1 anti-solvent:solvent). Filter the precipitate using a glass frit and dry under vacuum overnight.

### Example 8

Preparation of poly(hexanal): A 100 mL round bottom flask with a stir bar and distillation glassware was removed from the oven and cooled inside a desiccator. Once cooled to room temperature, the distillation apparatus was assembled with ˜1 g of molecular sieves in the receiving flask. The 100 mL flask and distillation apparatus were flame dried under vacuum three times and cooled under a blanket of Argon. Once cooled, 75 mL of hexanal (TCI) was added to the distillation flask and was distilled under Argon (hexanal bp ˜129° C. at 760 torr). After the distillation was complete, 8 mL of freshly distilled hexanal (65.2 mmol) was added to the 50 mL flask and was diluted with 32 mL of anhydrous THF (2M). The flask was cooled to −78° C. After 0.5 hour, 1 mL n-butyl lithium (1.6M, 1.63 mmol, 0.025 molar equivalents) was added to the round bottom flask. Stir under Argon for 5 h. The solution may become viscous. To the polymerization reaction, add N,N-Diisopropylethylamine (DIEA) (3.75 mL, 21.5 mmol, 0.33 molar equivalents), and then butyric chloride (1.67 mL, 16.3 mmol, 0.25 molar equivalents) at a rate of 1 mL/min (running the reagents down the inside of the cold flask) and ensure that the end-capping reagents are mixed through the viscous polymer solution. The solution was stirred at −78° C. for 16 hours, then warm to room temperature over 2 hours. Once at room temperature, precipitate into methanol (4:1 anti-solvent:solvent) by pouring the viscous solution all at once. Filter the precipitate using a glass frit and dry under vacuum overnight.

Purification of poly(hexanal): Dissolve poly(hexanal) in 18 mL THF. Once dissolved, add 0.1 mL 1,8-Diazabicyclo[5.4.0]undec-7-ene (DBU). Stir for 30 min and then precipitate into methanol (4:1 anti-solvent:solvent). Filter the precipitate using a glass frit and dry under vacuum overnight. Dissolve poly(hexanal) in 15 mL THF. Once dissolved, 10 mg of sodium hydride (NaH) was added. Stir for 30 min and then precipitate into methanol (4:1 anti-solvent:solvent). Filter the precipitate using a glass frit and dry under vacuum overnight.

### Example 9

Preparation of poly(lilial): A 300 mL round bottom flask with a stir bar and distillation glassware was removed from the oven and cooled inside a desiccator. Once cooled to room temperature, the distillation apparatus was assembled with ˜5 g of molecular sieves in the receiving flask. The 300 mL flask and distillation apparatus were flame dried under vacuum three times and cooled under a blanket of Argon. Once cooled, 150 mL of lilial (TCI) was added to the distillation flask and was distilled under vacuum. After the distillation was complete, 107 mL of freshly distilled lilial (500 mmol) was added to the 500 mL flask and was diluted with 250 mL of anhydrous toluene (2M), then 1 mL of 15-crown-5 was added. The flask was cooled to −78° C. After 1 hour, 3.125 mL n-butyl lithium (1.6M, 5 mmol, 0.01 molar equivalents) was added to the round bottom flask. Stir under Argon for 5 h. The solution may become viscous. To the polymerization reaction, add N,N-Diisopropylethylamine (DIEA) (13 mL, 75 mmol, 0.15 molar equivalents), and then tert-butyldimethylsilyl trifluoromethanesulfonate (11.5 mL, 50 mmol, 0.1 molar equivalents) at a rate of 5 mL/min (running the reagents down the inside of the cold flask) and ensure that the end-capping reagents are mixed through the viscous polymer solution. Stirred at −78° C. for 16 hours, then warm to room temperature over 2 hours. Once at room temperature, precipitate into methanol (4:1 anti-solvent:solvent) by pouring the viscous solution all at once. Filter the precipitate using a glass frit and dry under vacuum overnight.

Purification of poly(lilial): Dissolve poly(lilial) in 1000 mL THF. Once dissolved, add 2 mL 1,8-Diazabicyclo[5.4.0]undec-7-ene (DBU). Stir for 30 min and then precipitate into methanol (4:1 anti-solvent:solvent). Filter the precipitate using a glass frit and dry under vacuum overnight. Dissolve poly(lilial) in 500 mL THF and then precipitate into methanol (4:1 anti-solvent:solvent). Filter the precipitate using a glass frit and dry under vacuum overnight.

### Example 10

Preparation of poly(nonanal): A 300 mL round bottom flask with a stir bar and distillation glassware was removed from the oven and cooled inside a desiccator. Once cooled to room temperature, the distillation apparatus was assembled with ˜5 g of molecular sieves in the receiving flask. The 300 mL flask and distillation apparatus were flame dried under vacuum three times and cooled under a blanket of Argon. Once cooled, 150 mL of nonanal (TCI) was added to the distillation flask and was distilled under vacuum. After the distillation was complete, 90 mL of freshly distilled nonanal (526 mmol) was added to the 500 mL flask and was diluted with 250 mL of anhydrous toluene (2M). The flask was cooled to −70° C. After 1 hour, 8.2 mL n-butyl lithium (1.6M, 13.15 mmol, 0.025 molar equivalents) was added to the round bottom flask. Stir under Argon for 6 h. The solution may become viscous. To the polymerization reaction, add N,N-Diisopropylethylamine (DIEA) (30 mL, 173 mmol, 0.33 molar equivalents), and then butyric chloride (13.5 mL, 131 mmol, 0.25 molar equivalents) at a rate of 5 mL/min (running the reagents down the inside of the cold flask) and ensure that the end-capping reagents are mixed through the viscous polymer solution. Stirred at −70° C. for 16 hours, then warm to room temperature over 2 hours. Once at room temperature, precipitate into methanol (4:1 anti-solvent:solvent) by pouring the viscous solution all at once. Filter the precipitate using a glass frit and dry under vacuum overnight.

Purification of poly(nonanal): Dissolve poly(nonanal) in 250 mL THF then 10 mg of sodium hydride (NaH) was added. Stir for 30 min and then precipitate into methanol (4:1 anti-solvent:solvent). Filter the precipitate using a glass frit and dry under vacuum overnight. Dissolve poly(nonanal) in 250 mL THF then precipitate into methanol (4:1 anti-solvent:solvent). Filter the precipitate using a glass frit and dry under vacuum overnight. Determine if hydrogen end-capped polymer is present using a heat-cool-heat cycle. If hydrogen end-capped polymer is present, repeat NaH treatment until no hydrogen end-capped polymer is present using DSC.

Verification of purity of poly(nonanal): Run a heat-cool-heat cycle DSC experiment on poly(nonanal) from −50° C. to 125° C. at a ramp rate of 5°/min. Check to see if any monomer is present on the second heat cycle.

### Example 11

Preparation of poly(octanal): A 300 mL round bottom flask with a stir bar and distillation glassware was removed from the oven and cooled inside a desiccator. Once cooled to room temperature, the distillation apparatus was assembled with ˜5 g of molecular sieves in the receiving flask. The 300 mL flask and distillation apparatus were flame dried under vacuum three times and cooled under a blanket of Argon. Once cooled, 150 mL of octanal (TCI) was added to the distillation flask and was distilled under vacuum. After the distillation was complete, 100 mL of freshly distilled octanal (641 mmol) was added to the 500 mL flask and was diluted with 213 mL of anhydrous toluene (3M). The flask was cooled to −65° C. After 1 hour, 2.564 mL n-butyl lithium (2.5M, 6.41 mmol, 0.01 molar equivalents) was added to the round bottom flask. Stir under Argon for 16 h. The solution may become viscous. To the polymerization reaction, add N,N-Diisopropylethylamine (DIEA) (16.7 mL, 96.15 mmol, 0.15 molar equivalents), and then tert-butyldimethylsilyl trifluoromethanesulfonate (14.7 mL, 64 mmol, 0.15 molar equivalents) at a rate of 5 mL/min (running the reagents down the inside of the cold flask) and ensure that the end-capping reagents are mixed through the viscous polymer solution. Then warm to room temperature over 2 hours. Once at room temperature, precipitate into methanol (4:1 anti-solvent:solvent) by pouring the viscous solution all at once. Filter the precipitate using a glass frit and dry under vacuum overnight.

Purification of poly(octanal): Dissolve poly(octanal) in 100 mL THF. Once dissolved, add 5 mL 1,8-Diazabicyclo[5.4.0]undec-7-ene (DBU). Stir for 30 min and then precipitate into methanol (4:1 anti-solvent:solvent). Filter the precipitate using a glass frit and dry under vacuum overnight. Dissolve poly(octanal) in 100 mL THF then 10 mg of sodium hydride (NaH) was added. Stir for 30 min and then precipitate into methanol (4:1 anti-solvent:solvent). Filter the precipitate using a glass frit and dry under vacuum overnight. Dissolve poly(octanal) in 100 mL THF then precipitate into methanol (4:1 anti-solvent:solvent). Filter the precipitate using a glass frit and dry under vacuum overnight. Determine if hydrogen end-capped polymer is present using a heat-cool-heat cycle. If hydrogen end-capped polymer is present, repeat NaH treatment until no hydrogen end-capped polymer is present using DSC.

Verification of purity of poly(octanal): Run a heat-cool-heat cycle DSC experiment on poly(octanal) from −50° C. to 125° C. at a ramp rate of 5°/min. Check to see if any monomer is present on the second heat cycle.

### Example 12

Preparation of poly(pentanal): A 300 mL round bottom flask with a stir bar and distillation glassware was removed from the oven and cooled inside a desiccator. Once cooled to room temperature, the distillation apparatus was assembled with ˜5 g of molecular sieves in the receiving flask. The 300 mL flask and distillation apparatus were flame dried under vacuum three times and cooled under a blanket of Argon. Once cooled, 150 mL of pentanal (TCI) was added to the distillation flask and was distilled under Argon (pentanal bp ˜103° C. at 760 torr). After the distillation was complete, 105 mL of freshly distilled pentanal (988 mmol) was added to the 500 mL flask and was diluted with 330 mL of anhydrous THF (3M). The flask was cooled to −70° C. After 1 hour, 6.175 mL n-butyl lithium (1.6M, 9.88 mmol, 0.01 molar equivalents) was added to the round bottom flask. Stir under Argon for 5 h. The solution may become viscous. To the polymerization reaction, add N,N-Diisopropylethylamine (DIEA) (56 mL, 326 mmol, 0.33 molar equivalents), and then butyric chloride (25 mL, 247 mmol, 0.25 molar equivalents) at a rate of 5 mL/min (running the reagents down the inside of the cold flask) and ensure that the end-capping reagents are mixed through the viscous polymer solution. The solution was stirred at −70° C. for 16 hours, then warm to room temperature over 2 hours. Once at room temperature, precipitate into methanol (4:1 anti-solvent:solvent) by pouring the viscous solution all at once. Filter the precipitate using a glass frit and dry under vacuum overnight.

Purification of poly(pentanal): Dissolve poly(pentanal) in 500 mL THF. Once dissolved, add 1 mL 1,8-Diazabicyclo[5.4.0]undec-7-ene (DBU) dropwise. Stir for 30 min and then precipitate into methanol (4:1 anti-solvent:solvent). Filter the precipitate using a glass frit and dry under vacuum overnight. Dissolve poly(pentanal) in 200 mL THF. Once dissolved, add 1 mL 1,8-Diazabicyclo[5.4.0]undec-7-ene (DBU) dropwise. Stir for 30 min and then precipitate into methanol (4:1 anti-solvent:solvent). Filter the precipitate using a glass frit and dry under vacuum overnight.

### Example 13

Preparation of poly(propanal): A 300 mL round bottom flask with a stir bar and distillation glassware was removed from the oven and cooled inside a desiccator. Once cooled to room temperature, the distillation apparatus was assembled with ˜5 g of molecular sieves in the receiving flask. The 300 mL flask and distillation apparatus were flame dried under vacuum three times and cooled under a blanket of Argon. Once cooled, 160 mL of propanal (TCI) was added to the distillation flask and was distilled under Argon (propanal bp ˜49° C. at 760 torr). After the distillation was complete, 145 mL of freshly distilled propanal (2050 mmol) was added to the 500 mL flask and was diluted with 205 mL of anhydrous THF (10M). The flask was cooled to −78° C. After 1 hour, 6.4 mL n-butyl lithium (1.6M, 10.25 mmol, 0.005 molar equivalents) was added to the round bottom flask. Stir under Argon for 16 h. The solution may become viscous. To the polymerization reaction, add N,N-Diisopropylethylamine (DIEA) (53 mL, 308 mmol, 0.15 molar equivalents), and then tert-butyldimethylsilyl trifluoromethanesulfonate (47 mL, 205 mmol, 0.1 molar equivalents) at a rate of 5 mL/min (running the reagents down the inside of the cold flask) and ensure that the end-capping reagents are mixed through the viscous polymer solution. Then warm to room temperature over 2 hours. Once at room temperature, precipitate into methanol (4:1 anti-solvent:solvent) by pouring the viscous solution all at once. Filter the precipitate using a glass frit and dry under vacuum overnight.

Purification of poly(propanal): Dissolve/suspend poly(propanal) in BHT-free THF (4 mL THF/gram of polymer). Once dissolved/suspend, add 1,8-Diazabicyclo[5.4.0]undec-7-ene (DBU) dropwise (0.1 mL DBU/gram of polymer). Stir for 30 min and then precipitate into methanol (4:1 anti-solvent:solvent). Filter the precipitate using a glass frit and dry under vacuum overnight. Dissolve/suspend poly(propanal) in THF (4 mL THF/gram of polymer). Precipitate into methanol (4:1 anti-solvent:solvent). Filter the precipitate using a glass frit and dry under vacuum overnight.

### Example 14

Preparation of a copolymer of propanal and octanal (i.e., poly(propanal-co-octanal): A 100 mL round bottom flask with a stir bar and distillation glassware was removed from the oven and cooled inside a desiccator. Once cooled to room temperature, the distillation apparatus was assembled with ˜1 g of molecular sieves in the receiving flask. The 100 mL flask and distillation apparatus were flame dried under vacuum three times and cooled under a blanket of Argon. Once cooled, 50 mL of propanal (TCI) was added to the distillation flask and was distilled under Argon (propanal bp ˜49° C. at 760 torr). Octanal was distilled under identical conditions, but under vacuum. After the distillation was complete, 30 mL of freshly distilled propanal (418 mmol) and 6.5 mL of octanal (41.8 mmol) was added to the 250 mL flask and was diluted with 65 mL of anhydrous THF (7M). The flask was cooled to −78° C. After 1 hour, 6.5 mL n-butyl lithium (1.6M, 11.5 mmol, 0.025 molar equivalents) was added to the round bottom flask. Stir under Argon for 16 h. The solution may become viscous. To the polymerization reaction, add N,N-Diisopropylethylamine (DIEA) (26 mL, 152 mmol, 0.33 molar equivalents), and then butyric chloride (12 mL, 115 mmol, 0.25 molar equivalents) at a rate of 2 mL/min (running the reagents down the inside of the cold flask) and ensure that the end-capping reagents are mixed through the viscous polymer solution. Stirred for an additional 24 hours, then warm to room temperature over 2 hours. Once at room temperature, precipitate into methanol (4:1 anti-solvent:solvent) by pouring the viscous solution all at once. Filter the precipitate using a glass frit and dry under vacuum overnight.

Purification of poly(propanal-co-octanal): Dissolved poly(propanal-co-octanal) in 125 mL of Toluene. Once dissolved, 10 mg of sodium hydride (NaH) was added. Stir for 30 min and then precipitate into methanol (4:1 anti-solvent:solvent). Filter the precipitate using a glass frit and dry under vacuum overnight.

### Example 15

Preparation of poly(methional): A 300 mL round bottom flask with a stir bar and distillation glassware was removed from the oven and cooled inside a desiccator. Once cooled to room temperature, the distillation apparatus was assembled with ˜5 g of molecular sieves in the receiving flask. The 300 mL flask and distillation apparatus were flame dried under vacuum three times and cooled under a blanket of Argon. Once cooled, 150 mL of methional was added to the distillation flask and was distilled under vacuum. After the distillation was complete, 90 mL of freshly distilled methional (865 mmol) was added to the 500 mL flask and was diluted with 173 mL of anhydrous toluene (5M) and 12-crown-4 (1.4 mL, 8.65 mmol, 0.01 molar equivalents). The flask was cooled to −78° C. After 1 hour, 3.46 mL n-butyl lithium (2.5M, 8.65 mmol, 0.01 molar equivalents) was added to the round bottom flask. Stir under Argon for 6 h. The solution may become viscous. To the polymerization reaction, add N,N-Diisopropylethylamine (DIEA) (22.5 mL, 130 mmol, 0.15 molar equivalents), and then tert-butyldimethylsilyl trifluoromethanesulfonate (20 mL, 87 mmol, 0.15 molar equivalents) at a rate of 5 mL/min (running the reagents down the inside of the cold flask) and ensure that the end-capping reagents are mixed through the viscous polymer solution. Stirred at −78° C. for 16 hours, then warmed to room temperature over 2 hours. Once at room temperature, precipitate into methanol (4:1 anti-solvent:solvent) by pouring the viscous solution all at once. Filter the precipitate using a glass frit and dry under vacuum overnight.

Purification of poly(methional): Dissolve poly(methional) in 150 mL THF. Once dissolved, 1 mL 1,8-Diazabicyclo[5.4.0]undec-7-ene (DBU) was added, stirred for 30 min and then precipitate into methanol (4:1 anti-solvent:solvent). Filter the precipitate using a glass frit and dry under vacuum overnight.

### Example 16

Preparation of poly(2-phenylethanal) via Lewis Acid-catalyzed conditions: A 100 mL round bottom flask with a stir bar and distillation glassware was removed from the oven and cooled inside a desiccator. Once cooled to room temperature, the distillation apparatus was assembled with ˜1 g of molecular sieves in the receiving flask. The 100 mL flask and distillation apparatus were flame dried under vacuum three times and cooled under a blanket of Argon. Once cooled, 50 mL of 2-phenylethanal was added to the distillation flask and was distilled under vacuum. After the distillation was complete, 5 mL of freshly distilled 2-phenylethanal (45 mmol) was added to the 50 mL flask and was diluted with 22 mL of anhydrous THF (2M. The flask was cooled to −78° C. After 0.5 hour, 5.5 μL boron trifluoride-etherate (0.045 mmol, 0.001 molar equivalents) was added to the round bottom flask. Stir under Argon for 6 h. The solution may become viscous. To the polymerization reaction, pyridine (0.36 mL, 4.5 mmol, 0.1 molar equivalents) was added at a rate of 1 mL/min (running the reagents down the inside of the cold flask) and ensure that the end-capping reagents are mixed through the viscous polymer solution. Stirred at −78° C. for 16 hours, then warm to room temperature over 2 hours. Once at room temperature, precipitate into methanol (4:1 anti-solvent:solvent) by pouring the viscous solution all at once. Filter the precipitate using a glass frit and dry under vacuum overnight.

Purification of poly(2-phenylethanal): Dissolve poly(2-phenylethanal) in 15 mL THF. Once dissolved, add 0.1 mL 1,8-Diazabicyclo[5.4.0]undec-7-ene (DBU). Stir for 30 min and then precipitate into methanol (4:1 anti-solvent:solvent). Filter the precipitate using a glass frit and dry under vacuum overnight.

Representative Differential Scanning Calorimetry (DSC) method for analyzing whether hydrogen end-capped polymer is present as a contaminant in reagent end-capped polymer: 10 mg of poly(octanal) was added to an aluminum DSC pan and was hermetically sealed. The sample was place inside a TA instruments Q 2000 DSC. A heat-cool-heat cycle DSC experiment was run from −50° C. to 140° C. at a ramp rate of 5° C./min. If hydrogen end-capped poly(octanal) is present it will depolymerize to octanal and will appear as endothermic peak on the second heat cycle at −26° C. In preferred embodiments, the cooling cycle will extend to −180° C.

Demonstration of thermal recycling of solid plastic to monomer: A 25 mL round bottom flask with a stir bar and distillation glassware was removed from the oven and cooled inside a desiccator. Once cooled to room temperature, the distillation apparatus was assembled, flame dried under vacuum three times, and cooled under a blanket of Argon. Once cooled, 6.2 grams of poly(propanal) was added to the distillation flask and lowered into an oil bath at 140° C. while the receiving flask was lowered into an ice bath. Poly(propanal) began to depolymerize and distill over to the receiving flask while the temperature of the oil bath was incrementally increased to 190° C. over the course of 1 hour. After 1 hour, the distillation was complete with 5.9 grams collected in the receiving flask. 1H NMR was conducted on the material collected in the receiving flask which shows the product of depolymerization is propanal.

Demonstration of improved stability: Referring to Table 1 above, poly(acetal)s increase in stability when washed with base to remove residual proton end-capped polymer (compare 610, 620, and 630).

Demonstration of improved stability, part 2: Referring to Table 2 above, (i) end caps can be selected for stability (compare 730 versus 740); (ii) longer polymers are more stable than shorter polymers (compare 750 versus 770, as well as 780 versus 790); (iii) repeating units with increasing degrees of hydrophobicity improve the thermal stability of poly(acetal)s (compare 740 versus 760); and (iv) branched repeating units improve the thermal stability as well (compare 760 versus 780 and 790).

Demonstration of substrate scope: Table 3 above depicts a variety of poly(acetal)s that were prepared using either anionic or Lewis Acid-catalyzed polymerization conditions followed by implementing purification steps to remove hydrogen end-capped polymer and the corresponding monomer.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

The terms “comprise,” “have,” and “include” are open-ended linking verbs. Any forms or tenses of one or more of these verbs, such as “comprises,” “comprising,” “has,” “having,” “includes,” and “including,” are also open-ended. For example, any method that “comprises,” “has,” or “includes” one or more steps is not limited to possessing only those one or more steps and also covers other unlisted steps.

As used herein, words of approximation such as, “without limitation”, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

The present disclosure has been described above in terms of presently preferred embodiments so that an understanding of the present disclosure can be conveyed. However, there are other embodiments not specifically described herein for which the present disclosure is applicable. Therefore, the present disclosure should not be seen as limited to the forms shown, which is to be considered illustrative rather than restrictive.

Although various embodiments have been shown and described, the present disclosure is not so limited and will be understood to include all such modifications and variations as would be apparent to one skilled in the art.

What is claimed is:

1. A substance comprising:
polymers that include reagent end-capped poly(acetal)s, wherein a differential scanning calorimetry process exhibits no endothermic peaks for monomers for a first heat cycle of a heat-cool process applied to the reagent end-capped poly(acetal)s and for a second heat cycle of the heat-cool process, wherein the first heat cycle and the second heat cycle extend to a temperature at which hydrogen end-capped poly(acetal)s thermally depolymerize, and wherein a cooling cycle of the heat-cool process extends to −180° C.

2. The substance of claim 1, wherein the first heat cycle reaches a temperature in the range of 100° C. to 150° C.

3. The substance of claim 2, wherein the first heat cycle reaches a temperature that is at least 5° C. higher than the temperature at which hydrogen end-capped poly(acetal)s thermally depolymerize.

4. The substance of claim 1 in which the cooling cycle extends to between −80° C. and −180° C.

5. The substance of claim 4, wherein the cooling cycle extends to at least −100° C.

6. The substance of claim 1, wherein the polymers comprise polymerized residues of a formula: 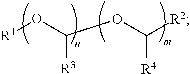
wherein n ranges from 1 to 1000 units and m ranges from 0 to 1000 units to form a random or block copolymer, a crosslinked derivative of the formula, a cyclic polymer, or polymers with atactic, syndiotactic, or isotactic stereochemical configurations;
wherein each R¹ is independently, (C₁-C₂₀)alkyl, allyl, 1-propynyl, 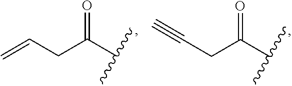
benzyl, triphenylmethyl, 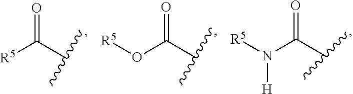
—SiR⁵, furfuryl, or R⁶, or substituents containing alkynes, alkenes, maleimide, silyl ethers, a carbon-bromine bond, or furan;
wherein each R² is, independently, (C₁-C₂₀)alkyl, isopropyl, tert-butyl, phenyl, benzyl, allyl, 1-propynyl, 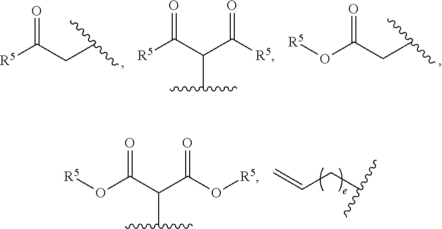
(where e ranges from 1 to 20 in this example and in each of the examples in which e is referenced), 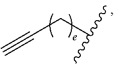
furfuryl, or substituents containing alkynes, alkenes, maleimide, silyl ethers, a carbon-bromine bond, or furan;
wherein each R³ and each R⁴ are independently, Ethanal, Propanal, Butanal, Isobutyraldehyde, Pentanal, Hexanal, Heptanal, Octanal, Nonanal, Decanal, Undecanal, 10-undecanal, Dodecanal, 2-methylbutyraldehyde, 2-methylpentanal, 2-ethylhexanal, propanal/octanal co-polymer, 3-(Methylthio)propionaldehyde (methional), beta-methylmercapto-propionaldehyde, beta-ethylmercapto-propionaldehyde, beta-propylmercapto-propionaldehyde, beta-n-butylmercapto-propionaldehyde, beta-hexylmercapto-propionaldehyde, beta-phenylmercapto-propionaldehyde, beta-methylmercapto-butyraldehye, beta-ethylmercapto-butyraldehye, beta-propylmercapto-butyraldehye, beta-n-butylmercapto-butyraldehye, beta-hexylmercapto-butyraldehye, beta-phenylmercapto-butyraldehye, cyclohexanecarboxaldehyde, cyclohex-3-enecarboxaldehyde, 5-Norborene-2-carboxaldehyde, 2-phenylethanal, 2-phenylpropanal, 3-phenylpropanal, 3-phenylbutyraldehyde, furfural, 2-methyl-3-(3,4-methylenedioxyphenyl)propionylaldehyde (helional), 3-(4-tert-Butylphenyl)-2-methylpropanal (lilial), 3-(4-Isopropylphenyl)-2-methylpropanal (cyclamen aldehyde), 2,2,2-trichloroacetaldehyde (chloral), 2,2,2-trichloroacetaldehyde, 2-bromo-2,2-dichloroacetaldehyde, 2,2-dibromo-2-chloroacetaldehyde, 2,2,2-tribromoacetaldehyde;
wherein each R⁵ is independently (C₁-C₂₀)alkyl, phenyl, benzyl, allyl, furfuryl, or 1-propynyl, or substituents containing alkynes, alkenes, maleimide, silyl ethers, a carbon-bromine bond, 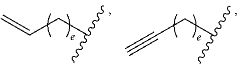
or furan;
wherein e ranges from 1 to 20 units; and
wherein R⁶ is an end cap that cleaves in response to a specific applied stimulus.

7. The substance of claim 6, wherein R⁶ is, independently, 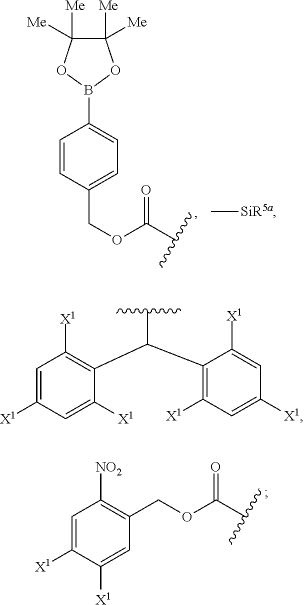
or a stimuli-responsive end cap;
wherein each R^{5a} is, independently, (C₁-C₂₀)alkyl, phenyl, benzyl, allyl, furfuryl, or 1-propynyl, or substituents containing alkynes, alkenes, maleimide, silyl ethers, a carbon-bromine bond, 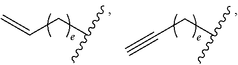
or furan;
wherein each X¹ is, independently, H, (C1-C20)alkoxy, or NR^{5b}, and
wherein each R^{5b} is, independently, (C1-C20)alkyl.

8. The substance of claim 1, wherein the reagent end-capped poly(acetal)s includes silicon-oxygen bonds between terminal oxygens of the reagent end-capped poly(acetal)s and silicones of end caps of the reagent end-capped poly(acetal)s.

9. The substance of claim 6, wherein repeating units contain branching functionality at their respective alpha and beta positions relative to the acetal carbon.

10. The substance of claim 6, wherein R³ and R⁴ are hydrophobic.

11. The substance of claim 1, further comprising additives for stabilizing the polymer, wherein the additives include acid scavengers, aldehyde scavengers, antioxidants, or combinations thereof.

12. The substance of claim 11, wherein the acid scavengers include calcium carbonate, triethyl amine, or 1,8-Diazabicyclo[5.4.0]undec-7-ene.

13. The substance of claim 11, wherein the aldehyde scavengers include amines, hydrazines, or 2-aminobenzamide.

14. The substance of claim 1, wherein the polymer includes poly(alkyl aldehyde)s that are longer than 15 kDa.

15. The substance of claim 1, wherein the polymer includes poly(alkyl aldehyde)s that are longer than 50 kDa

16. The substance of claim 1, wherein the polymer includes poly(alkyl aldehyde)s that are longer than 100 kDa.

17. The substance of claim 1, wherein the polymer is atactic, syndiotactic, or isotactic.

18. The substance of claim 1, wherein the end caps of the reagent end-capped polymer reacts to at least one non-ambient stimuli selected from the group consisting of base, acid, oxidizing agent, reducing agent, non-ionizing radiation, ultrasound, acid derived from a photoacid, ultraviolet light, infrared light, visible light, extreme ultraviolet radiation, and heat, wherein the non-ambient stimuli causes cleavage of the end cap from a terminus of the polymer.

19. A method for obtaining stable polyacetals, the method comprising:
synthesizing a polymer substance, wherein the polymer substance includes a hydrogen end-capped polymer and a reagent end-capped polymer; and
removing the hydrogen end-capped polymer from the polymer substance.

20. The method of claim 19, wherein removing the hydrogen end-capped polymer comprises:
exposing the polymer substance to a base; and
separating the polymer from the products of depolymerization.

21. The method of claim 19, wherein removing the hydrogen end-capped polymer comprises:
heating the polymer mixture to a temperature that decomposes the hydrogen end-capped polymer, but not the reagent end-capped polymer; and
separating the polymer from the products of depolymerization.

22. The method of claim 19, wherein removing the hydrogen end-capped polymer comprises:
washing or storage of the polymer mixture for sufficient duration to cause depolymerization of the hydrogen end-capped polymer selectively over the reagent end-capped polymer; and
separating the polymer from the products of depolymerization.

23. The method of claim 19, wherein the polymer substance comprises polymerized residues of a formula: 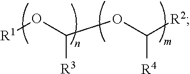
wherein n ranges from 1 to 1000 units and m ranges from 0 to 1000 units to form a random or block copolymer, a crosslinked derivative of the formula, a cyclic derivative of the formula, or polymers with atactic, syndiotactic, or isotactic stereochemical configurations;
wherein each R¹ is independently, (C₁-C₂₀)alkyl, allyl, 1-propynyl, 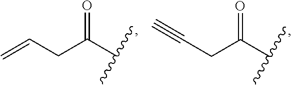
benzyl, triphenylmethyl, 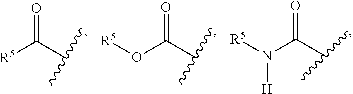
—SiR⁵, furfuryl, or R⁶, or substituents containing alkynes, alkenes, maleimide, silyl ethers, a carbon-bromine bond, or furan;
wherein each R² is, independently, (C₁-C₂₀)alkyl, isopropyl, tert-butyl, phenyl, benzyl, allyl, 1-propynyl, 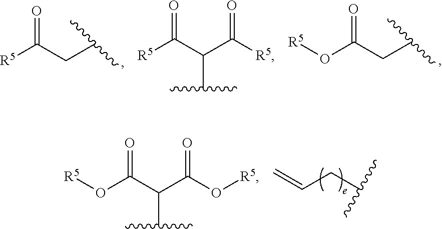
(where e ranges from 1 to 20 in this example and in each of the examples in which e is referenced), 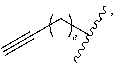
furfuryl, or substituents containing alkynes, alkenes, maleimide, silyl ethers, a carbon-bromine bond, or furan;
wherein each R³ and each R⁴ are independently, Ethanal, Propanal, Butanal, Isobutyraldehyde, Pentanal, Hexanal, Heptanal, Octanal, Nonanal, Decanal, Undecanal, 10-undecanal, Dodecanal, 2-methylbutyraldehyde, 2-methylpentanal, 2-ethylhexanal, propanal/octanal co-polymer, 3-(Methylthio)propionaldehyde (methional), beta-methylmercapto-propionaldehyde, beta-ethylmercapto-propionaldehyde, beta-propylmercapto-propionaldehyde, beta-n-butylmercapto-propionaldehyde, beta-hexylmercapto-propionaldehyde, beta-phenylmercapto-propionaldehyde, beta-methylmercapto-butyraldehye, beta-ethylmercapto-butyraldehye, beta-propylmercapto-butyraldehye, beta-n-butylmercapto-butyraldehye, beta-hexylmercapto-butyraldehye, beta-phenylmercapto-butyraldehye, cyclohexanecarboxaldehyde, cyclohex-3-enecarboxaldehyde, 5-Norborene-2-carboxaldehyde, 2-phenylethanal, 2-phenylpropanal, 3-phenylpropanal, 3-phenylbutyraldehyde, furfural, 2-methyl-3-(3,4-methylenedioxyphenyl)propionylaldehyde (helional), 3-(4-tert-Butylphenyl)-2-methylpropanal (lilial), 3-(4-Isopropylphenyl)-2-methylpropanal (cyclamen aldehyde), 2,2,2-trichloroacetaldehyde (chloral), 2,2,2-trichloroacetaldehyde, 2-bromo-2,2-dichloroacetaldehyde, 2,2-dibromo-2-chloroacetaldehyde, 2,2,2-tribromoacetaldehyde;
wherein each R⁵ is independently (C₁-C₂₀)alkyl, phenyl, benzyl, allyl, furfuryl, or 1-propynyl, or substituents containing alkynes, alkenes, maleimide, silyl ethers, a carbon-bromine bond, 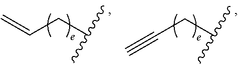
or furan;
wherein e ranges from 1 to 20 units; and
wherein R⁶ is an end cap that cleaves in response to a specific applied stimulus.

24. The method of claim 19, wherein the number average molecular weight of the polymer substance is between 400 kDa and 4000 kDa.

25. The method of claim 19, wherein the number average molecular weight of the polymer substance is between 500 kDa and 2000 kDa.

26. The method of claim 19, wherein the number average molecular weight of the polymer substance is between 500 kDa and 1000 kDa.

27. The method of claim 19, further comprising depolymerizing the polymers and recovering pure monomer from resulting depolymerization products.

28. The method of claim 19, further comprising:
exposing the polymers to acid vapor to depolymerize the polymers and recover pure monomers.

29. The method of claim 19, further comprising exposing the polymers to liquid acid to depolymerize the polymers and recover pure monomers.

30. The method of claim 19, further comprising applying signals that cleave an end cap from the polymers to depolymerize the polymers and recover pure monomers.

31. The method of claim 19, further comprising applying heat to the polymers to depolymerize the polymers and recover pure monomers.

32. The method of claim 19, further comprising fabricating materials from the polymers for use in extrusion, injection molding, heat press, solvent casting, or additive manufacturing.

33. The method of claim 19, further comprising forming the polymer substance into films, coatings, thermoplastics, elastomers, adhesives, foams, or thermosets.
